(19) United States
(12) Patent Application Publication
(10) Pub. No.: US 2025/0071609 A1
(43) Pub. Date: Feb. 27, 2025

(54) WIRELESS COMMUNICATION METHOD, USER EQUIPMENT AND BASE STATION

(71) Applicant: SHENZHEN TCL NEW TECHNOLOGY CO., LTD., Shenzhen (CN)

(72) Inventor: Liping WANG, Shenzhen (CN)

(73) Assignee: SHENZHEN TCL NEW TECHNOLOGY CO., LTD., Shenzhen (CN)

(21) Appl. No.: 18/943,676

(22) Filed: Nov. 11, 2024

Related U.S. Application Data
(63) Continuation of application No. PCT/CN2023/076946, filed on Feb. 17, 2023.

(51) Int. Cl. H04W 28/02; H04W 56/00

(52) U.S. Cl. CPC H04W 28/0278; H04W 56/004

(57) ABSTRACT

An uplink resource processing method is provided. A user equipment (UE) requests uplink resources from a gNB by sending a delay-contained buffer status report to the gNB or obtains from the gNB an indication of uplink resources allocated by the gNB, or the UE allocates the uplink resources to logical channels (LCHs) with delay information during a logical channel prioritization (LCP) procedure.

### CROSS REFERENCE TO RELATED APPLICATIONS

This application is a US national phase application based upon an International Application No. PCT/CN2023/076946, filed on Feb. 17, 2023 and entitled “WIRELESS COMMUNICATION METHOD, USER EQUIPMENT AND BASE STATION”. The entire disclosures of the above application are incorporated herein by reference.

### BACKGROUND OF DISCLOSURE

### 1. Field of Disclosure

The present disclosure relates to the field of telecommunication, and in particular to an uplink resource processing method, user equipment (UE) and a base station.

### 2. Description of Related Art

The 5G wireless communication system has been designed to deliver legacy services, such as enhanced mobile broadband (eMBB), ultra-reliable low-latency communication (URLLC), and massive machine type communication (mMTC) services. In 5G or NR, features supporting eMBB, URLLC, and mMTC was introduced in Release 15 and enhanced in Release 16 and 17.

Extended reality (XR) is an umbrella term covering Augmented Reality (AR), Mixed Reality (MR) and Virtual Reality (VR). XR applications typically require high throughput and low latency. Cloud Gaming is another application with the same requirement. XR and Cloud Gaming are important applications that will be enabled by 5G.

XR service is featured by its special traffic streams which are real-time, high data rate, and low latency. XR video streams have are different frames/video slices. For example, a group of pictures (GOP) has I/P/B frames. Some special characteristics of such an XR service stream should be considered and supported in 5G.

Extended reality (XR) and cloud gaming service is an important media application enabled by 5G. In 3GPP, a series of study items have been done and discovered that XR service has some unique characteristics while the current 5G system may not support XR service very well.

### Technical Problem

For legacy service, when scheduling the uplink service resources, the gNB should allocate resources based on the buffer size information reported by the UE in the BSR. The same mechanism may be followed by XR service. And it is possible that both legacy and XR service may exist simultaneously in the 5G and gNB need to schedule for the two kinds of services simultaneously. Since XR service has the characteristics of large data volume and jitter, in order to more accurately support the XR BSR, 3GPP has decided to enhance the XR BSR to report delay information as well as buffer size information. When two kinds of service (XR service and traditional legacy service) BSR are reported, how can a gNB perform differentiated scheduling based on the data volume reported by BSR of different services (XR services and traditional legacy services)?

Hence, an uplink resource processing method that provides an enhancement for XR service is desired.

### SUMMARY

An object of the present disclosure is to propose a UE and an uplink resource processing method.

In a first aspect, an embodiment of the invention provides an uplink resource processing method, executable in a user equipment (UE), comprising:
reporting a delay-contained buffer status report (BSR) to a base station; or
obtaining from the base station an indication of uplink resources allocated by the base station; or
allocating the uplink resources to logical channels (LCHs) with delay information during a logical channel prioritization (LCP) procedure.

In a second aspect, an embodiment of the invention provides a user equipment (UE) comprising a processor configured to call and run a computer program stored in a memory, to cause a device in which the processor is installed to execute the disclosed method.

In a third aspect, an embodiment of the invention provides an uplink resource processing method, executable in a base station, comprising:
receiving delay-contained buffer status report (BSR) from a user equipment (UE), wherein the delay-contained BSR includes delay information; or
allocating uplink resources in response to the delay-contained BSR; or
transmitting an indication of the allocated uplink resources.

In a fourth aspect, an embodiment of the invention provides a base station comprising a processor configured to call and run a computer program stored in a memory, to cause a device in which the processor is installed to execute the disclosed method.

The disclosed method may be implemented in a chip. The chip may include a processor, configured to call and run a computer program stored in a memory, to cause a device in which the chip is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read-Only Memory, a Programmable Read-Only Memory, an Erasable Programmable Read-Only Memory, EPROM, an Electrically Erasable Programmable Read-Only Memory and a Flash memory.

The disclosed method may be programmed as a computer program product, which causes a computer to execute the disclosed method.

The disclosed method may be programmed as a computer program, which causes a computer to execute the disclosed method.

### Advantageous Effects

In the description, embodiments are provided to address the issue of how to perform differentiated scheduling with two kinds of BSR reporting (XR service and traditional legacy service BSR). The disclosure provides: A mechanism in which a UE reports data volume of different services (XR services and traditional legacy services) by BSR (XR BSR and/or legacy BSR) simultaneously. A mechanism in which a gNB performs differentiated scheduling and differentiated resource allocation indication. A mechanism in which a UE performs resource allocation for two different services (XR services and traditional legacy services).

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 illustrates a schematic view of a telecommunication system.

FIG. 2 illustrates a schematic view showing an embodiment of a network for the disclosed uplink resource processing method.

FIG. 3 illustrates a schematic view showing protocol layers of a transmitter device and a receiver device.

FIG. 4 illustrates a schematic view showing an uplink data transmission procedure.

FIG. 5 illustrates a schematic view showing an uplink resource processing method according to an embodiment of the disclosure.

FIG. 6 illustrates a schematic view showing a relationship between LCG and LCH and PDU set.

FIG. 7 illustrates a schematic view showing two UL resources for the legacy service and XR service.

FIG. 8 is a block diagram of a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Abbreviations used in the description are listed in the following:

TABLE 1

| | |
|---|---|
| 3G | Third generation |
| 3GPP | Third Generation Partnership Project |
| 5GC | 5G Core Network |
| 5GS | 5G System |
| BS | Base station |
| BSR | Buffer status report |
| BSR | Buffer status reporting |
| CE | Control element |
| CN | Core network |
| eMMB | enhance Mobile Broadband |
| E-UTRAN | Evolved UMTS Territorial Radio Access |
| | Network |
| gNB | Generation Node B |
| ID | Identifier/Identification |
| LCG | logical channel group (LCG) |
| LCH | logical channel (LCH) |
| LTE | Long Term Evolution |
| MAC | Media Access Control |
| MTC | Machine type communication |
| NR | New Radio |
| PSII | PDU set Integrated Indication (PSII) |
| PUSCH | Physical uplink shared channel (PUSCH) |
| QoS | Quality of Service |
| RAN | Radio Access Network |
| Rel | Release |
| RLC | Radio Link Control |
| SDU | Service Data Unit |
| SR | Scheduling request |
| UE | User Equipment |
| URLLC | Ultra-Reliable and Low Latency |
| | Communication |
| UPF | User Plane Function |
| UL | Uplink |
| PBR | Prioritized Bit Rate (PBR) |
| BSD | Bucket Size Duration (BSD). |
| SCS | Subcarrier Spacing(s) (SCS) |
| LCP | Logical Channel Prioritization (LCP) |
| PSDB | PDU set delay budget (PSDB) |
| PDB | Packet delay budget (PDB) |

This invention disclosed an uplink resource processing method for processing extended reality (XR) traffic in extended reality (XR) service(s). XR service may include augmented reality (AR), virtual reality (VR), or mixed reality (MR). XR service has requirements different from legacy services, such as Ultra-reliable low-latency communication (URLLC), enhanced mobile broadband (eMBB), and massive machine type communication (mMTC). For simplicity, communication services other than XR service are referred to as non-XR service or legacy service.

In the description, packets, protocol data unit (PDU), and/or PDU sets of a service are referred to as traffic data for simplicity.

In the description, a packet may be a PDU or a SDU of a protocol layer. For simplicity, the term packet may refer to a PDU or SDU, and the term PDU may refer to a PDU or SDU. In the description, the term “resource” comprises radio resources in time and frequency domains.

A UE may transmit a buffer status report (BSR) to a gNB. The Buffer Status reporting (BSR) procedure is used to provide the serving gNB with information about uplink (UL) data volume in the MAC entity of the UE.

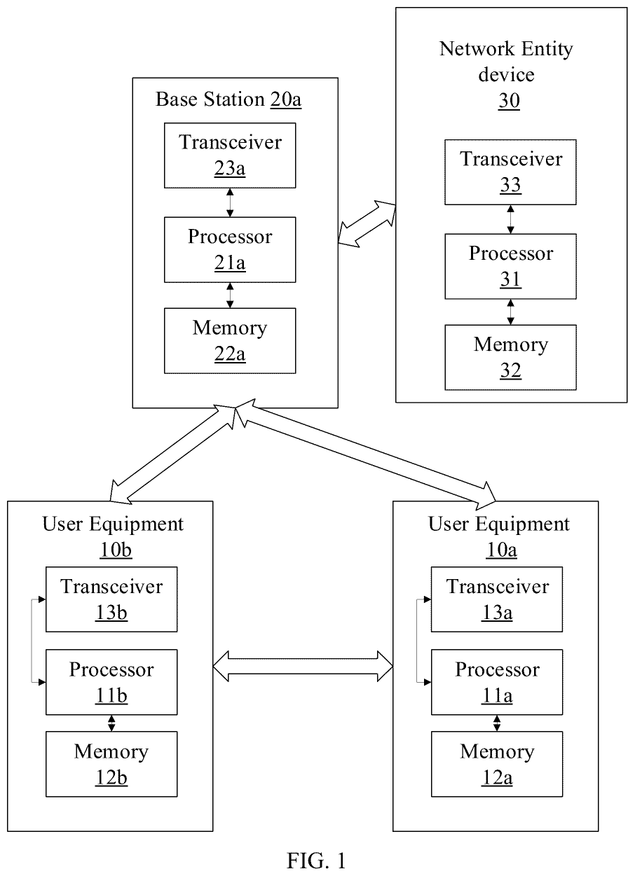

With reference to FIG. 1, a telecommunication system including a UE 10a, a UE 10b, a base station (BS) 20a, and a network entity device 30 executes the disclosed method according to an embodiment of the present disclosure. FIG. 1 is shown for illustrative, not limiting, and the system may comprise more UEs, BSs, and CN entities. Connections between devices and device components are shown as lines and arrows in the FIGs. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, transmits and/or receives radio signals or wireline signals. The UE 10a may be in communication with the UE 10b through a sidelink. The base station 20a may be an eNB, a gNB, or one of other types of radio nodes, and may configure radio resources for the UE 10a and UE 10b.

The network entity device 30 may be a node in a CN. CN may include LTE CN or 5G core (5GC) which includes user plane function (UPF), session management function (SMF), 5G core access and mobility management function (AMF), unified data management (UDM), policy control function (PCF), control plane (CP)/user plane (UP) separation (CUPS), authentication server (AUSF), network slice selection function (NSSF), and the network exposure function (NEF).

An example of the UE in the description may include one of the UE 10a or UE 10b. An example of the base station in the description may include the base station 20a. Uplink (UL) transmission of a control signal or data may be a transmission operation from a UE to a base station. Downlink (DL) transmission of a control signal or data may be a transmission operation from a base station to a UE. A DL control signal may comprise downlink control information (DCI) or a radio resource control (RRC) signal, from a base station to a UE.

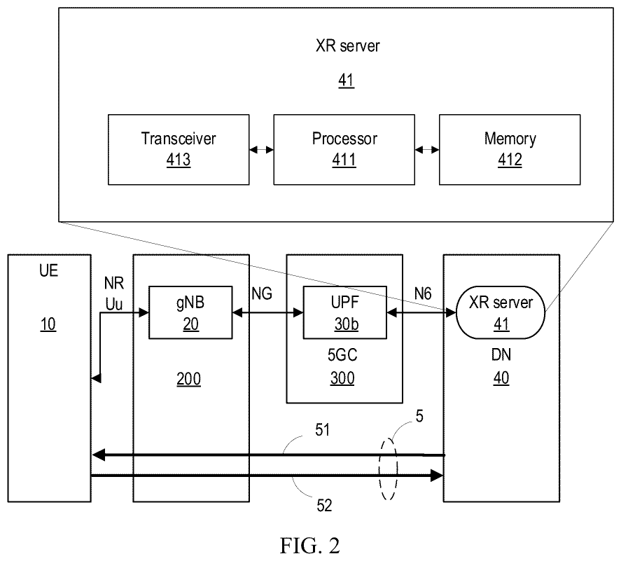

FIG. 2 is a model of a transport network for XR service supported by 5G system. A UE 10 is a 5G terminal which can support XR service and XR application and can be referred to as a client, a client terminal, or an XR client. A gNB 20 is 5G radio node. The gNB 20 communicates with the UE 10 and provides NR user plane and control plane protocol terminations towards the UE via NR Uu interface. The gNB 20 connects via NG interface to a 5GC 300. An UPF 30b is an UPF in the 5GC 300 which is a 5G Core Network. DN 40 is a data network (DN) 40 where an XR server 41 providing XR service is located. The DN 40 can provide network operator services, Internet access, or 3rd party services. The XR server 41 may include a processor 411, a memory 412, and a transceiver 413. The processor 411 may be configured to implement XR service related functions, procedures and/or methods described in the description. Layers of radio interface protocol may be implemented in the processor 411. The memory 412 operatively stores a variety of programs and information to operate a connected processor. The transceiver 413 is operatively coupled with a connected processor, transmits and/or receives radio signals or wireline signals.

Each of the processors 411, 11a, 11b, 21a, and 31 may include an application-specific integrated circuit (ASICs), other chipsets, logic circuits and/or data processing devices. Each of the memory 412, 12a, 12b, 22a, and 32 may include read-only memory (ROM), a random access memory (RAM), a flash memory, a memory card, a storage medium and/or other storage devices. Each of the transceivers 413, 13a, 13b, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art. A device executing the uplink resource processing method may be a transmitter device that transmits an XR traffic flow of an XR service to a receiver device or a receiver device that receives the XR traffic flow. The XR traffic flow may comprise one or more service traffic streams of the XR service. For example, the device executing the uplink resource processing method may comprise the gNB 20, an XR server 41 in data network 40, or a UE. That is, the XR server 41 in data network 40 may operate as a transmitter device that executes an uplink resource processing method in some XR traffic delivery occasions, while one or more XR clients (e.g., one or more of the UE 10, UE 10a, and UE 10b) operates as the receiver device receiving the XR traffic flow sent from the transmitter device. Similarly, an XR client (e.g., one or more of the UE 10, UE 10a, and UE 10b) may operate as a transmitter device to execute an uplink resource processing method in some XR traffic delivery occasions, while another XR client or the XR server 41 operates as the receiver device receiving the XR traffic flow sent from the transmitter device. Alternatively, the transmitter device may comprise an intermediate device between the UE 10 and the XR server 41. The UE 10 may comprise an embodiment of the UE 10a or UE 10b. The gNB 20 may comprise an embodiment of the base station 20a. Note that although the gNB 20 and UPF/5GC 30b are described as an example in the description, the uplink resource processing method may be executed by a base station, such as another gNB, an eNB, a base station integrating an eNB and a gNB, or a base station for beyond 5G technologies. The UPF/5GC 30b may comprise another network entity of 5GC.

A service traffic stream 5, such as an XR stream of an XR service, is established between the UE 10 and the XR server 41. The stream 5 comprises a traffic flow 51 from the XR server 41 to the UE 10 and a traffic flow 52 from the UE 10 to the XR server 41.

In the description, a layer, such as an application layer, a PDCP layer, an RLC layer, an MAC layer, or a physical layer (PHY layer or LI layer), may be a protocol layer entity in a transmitter device or a receiver device. A protocol layer entity may be implemented by a program or a software module executed by a processor or implemented by a hardware module in an integrated circuit (IC).

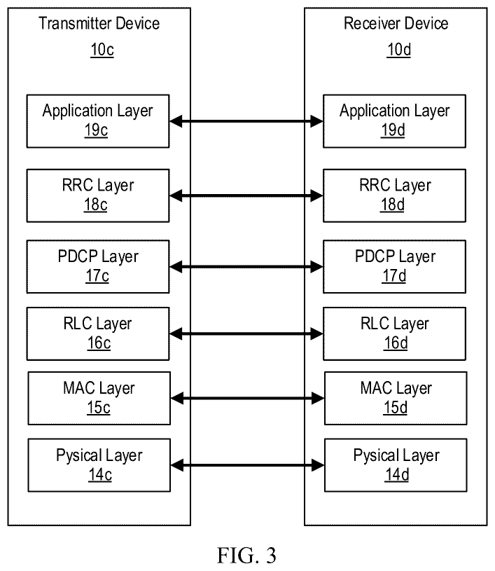

With reference to FIG. 3, an example of the transmitter device is shown as transmitter device 10c, and an example of the receiver device is shown as receiver device 10d. The transmitter device 10c comprises a physical layer (PHY layer or LI layer) 14c, MAC layer 15c, RLC layer 16c, PDCP layer 17c, RRC layer 18c, and application layer 19c. The receiver device 10d comprises a physical layer (PHY layer or LI layer) 14d, MAC layer 15d, RLC layer 16d, PDCP layer 17d, RRC layer 18d, and application layer 19d. For example, when the application layer 19c of the transmitter device 10c sends a PDU through lower layers (i.e., PDCP layer 17c, RLC layer 16c, MAC layer 15c, and physical layer 14c) to the application layer 19d of the receiver device 10d, the layers in transmitter device 10c serves as transmitting protocol layer entities at the transmitting side, and the layers in receiver device 10d serve as receiving protocol layer entities at the receiving side. Embodiments of the disclosed may be implemented in the PDCP layer or RLC layer. One or more steps (or blocks) in of embodiments of the disclosure may be implemented as computer programs, instructions, software module(s) stored in a memory of the transmitter device, or circuits or hardware module(s) in a processor of the transmitter device, or IC chip(s), circuits, or plug-in(s) of the transmitter device.

A video stream of an XR service will be encoded and compressed in form of frames quasi-periodically with the respective frame periodicity of 1/60, 1/90, or 1/120 the second. Since the transmitter device may divide a video stream of an XR service into a number of transport units, encapsulate and transmit each of the transport units into a transport packet transmitted across the network, the transmission mechanism of the XR service is actually based on packet instead of frame. The size of each of the packets may be variable, the number of the packets may be variable and configurable based on one or more parameters of the QoS requirements and characteristics of the XR service, such as packet delay budget (PDB), packet error rate (PER), packet loss rate (PLR), frame error rate, frame delay budget, resolution, frame rate, and/or data rate.

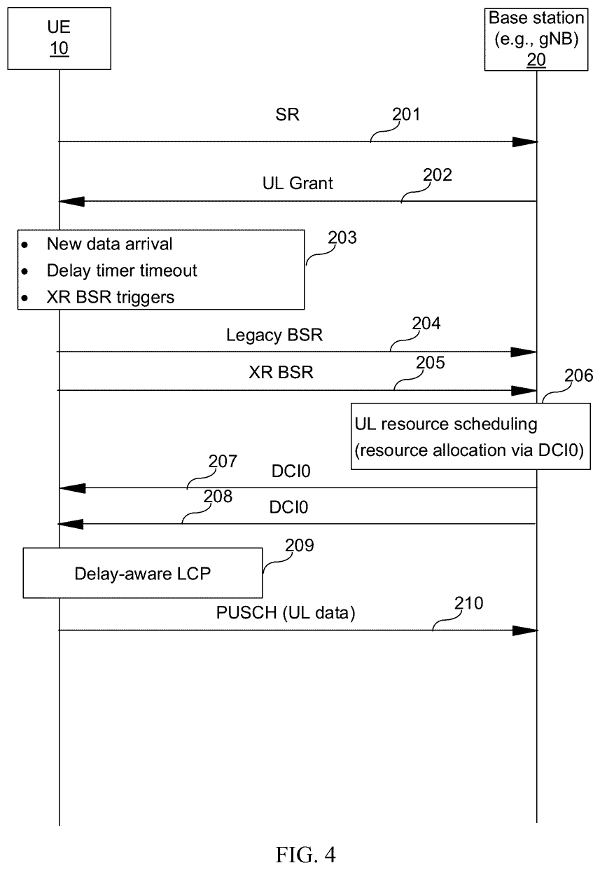

A base station, when performing an uplink resource scheduling procedure, may have no idea of how much data is waiting for transmission. Thus, as supported in 3GPP standard, a UE may perform buffer status reporting (BSR) to report the service data volume information (known as buffer size) to a base station for uplink scheduling. As shown in FIG. 4, for legacy service, the buffer status reporting (BSR) process is included in an uplink data transmission procedure.

The UE 10 transmits a scheduling request (SR) to base station 20 (201). The base station 20 receives the SR and transmits UL grant to the UE 10 in response to the SR (202).

The UE 10 detects BSR triggers including: New data arrival; Delay timer timeout; and XR BSR triggers.

The BSR triggers are detailed in the description. In response to one or more BSR triggers, the UE 10 transmits a legacy BSR (204) and an XR BSR (205) to the base station 20. The base station 20 receives the legacy BSR and the XR BSR and performs UL resource scheduling for the UE 10 in response to the legacy BSR and the XR BSR (206). The base station 20 transmits an indication of UL resources allocated by the base station 20 to the UE 10 using a first DCI0 (207) and a second DCI0 (208).

The UE 10 receives the first DCI0 and a second DCI0 and performs delay-aware LCP to allocate the UL resources indicated in the first DCI0 and a second DCI0 to logical channels (209). The UE 10 transmits PUSCH in the logical channels to the gNB 20 (210).

When having uplink data for uplink transmission, the UE needs to request uplink resources from the gNB. The UE first transmits to the gNB a scheduling request (SR) that indicates the UE has UL data that needs to be sent. The SR, however, does not indicate to the gNB the amount of data that needs to be sent. The BSR is responsible for indicating the amount of data for uplink transmission. The gNB may provide a UL grant to the UE for transmission of the BSR.

The BSR which the UE reports to the gNB has a format that uses logical channel group (LCG) a basic unit of granularity. In the BSR, each record of uplink data volume (known as buffer size) for sending is associated with one logical channel (LCH), and each LCH belongs to an LCG. The gNB controls the configuration relationship between LCH and LCG as well as the priority of each LCH. When performing LCH-to-LCG configuration, the gNB may aggregate LCHs with similar scheduling requirements into the same LCG. The task of LCH-to-LCG configuration requires the gNB to be aware of LCH information of the LCG reported in the BSR.

BSR is an uplink control message i.e., UL MAC CE. UL MAC CE is carried at a rear portion of an uplink UL MAC PDU (i.e., UL data first, then UL MAC CE second). The format of BSR includes a BSR MAC subhead and MAC CE payload. BSR MAC subhead indicates a type of BSR, such as a long BSR or a short BSR. A long BSR reports the amount of data of multiple LCGs while a short BSR reports the amount of data of only one LCG. MAC CE payload contains LCG ID(s) which needs to be reported and buffer size information of corresponding LCG(s). Buffer size information is a summary of the amount of data of each LCH belonging to the reported LCG. The definition of BSR may be found in 3GPP standards.

For legacy service, when a trigger condition of BSR is met, for example, a logical channel LCH with a higher priority (LCH belongs to logical channel group LCG) has new data arrives or a BSR timer timeout, the UE selects an appropriate BSR format and a BSR type to report to the gNB according to the actual situation.

After receiving the BSR from the UE, the gNB assigns uplink resources according to the buffer size information in the BSR, and subsequently indicates a DCI0 to the UE. After receiving the information on the uplink resources indicated in DCI0, the UE allocates the uplink resources to the corresponding logical channels according to logical channel priority and performs the uplink data transmission.

For XR service, when scheduling the uplink service resources, the gNB should likewise allocate resources for LCHs of XR services based on the buffer size information reported by the UE in the XR BSR. Since XR service has the characteristics of large data volume and jitter, in order to more accurately support the XR BSR, 3GPP has decided to enhance the XR BSR for XR and comes to a challenging issue: How can a gNB perform differentiated scheduling based on the data volume reported by BSR of different services (XR services and traditional legacy services)?

In the description, embodiments are provided to address the issue of how to perform differentiated scheduling with two kinds of BSR reporting (XR service and traditional legacy service BSR). The disclosure provides: A mechanism in which a UE reports data volume of different services (XR services and traditional legacy services) by BSR (XR BSR and/or legacy BSR) simultaneously. A mechanism in which a UE reports data volume of different services (XR services and traditional legacy services) by BSR (XR BSR and/or legacy BSR) simultaneously. A mechanism in which a gNB performs differentiated scheduling and differentiated resource allocation indication. A mechanism in which a UE performs resource allocation for two different services (XR services and traditional legacy services).

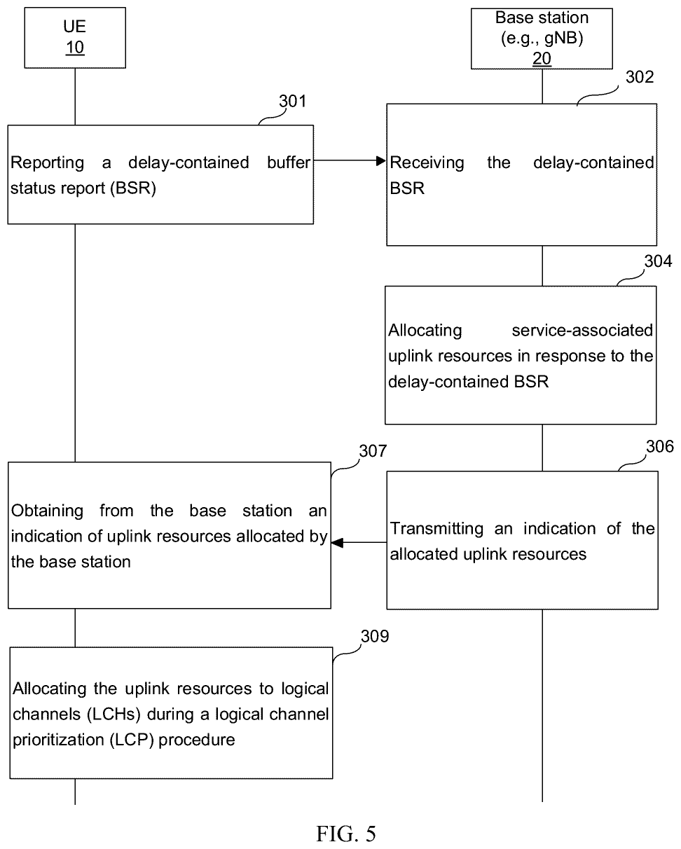

With reference to FIG. 5, the UE 10 and the gNB 20 execute an embodiment of the disclosed method and initiate a service. For example, the service may comprise an XR service, a critical mission service, a video streaming service, or a URLLC service.

The UE 10 requests uplink resources from a gNB by sending a request to the gNB 20. The gNB 20 receives a request for uplink resources from the UE 10, wherein the request includes delay information.

The UE 10 reports a delay-contained BSR to the gNB 20 (301). The gNB 20 receives the delay-contained BSR, wherein the delay-contained BSR includes delay information (302). The delay-contained BSR comprises delay information and buffer size of an LCH or an LCG or a PDU set. The delay information is remaining time of an LCH or an LCG or a PDU set. The buffer size is available data volume of an LCH or an LCG or a PDU set.

In an embodiment, in requesting uplink resources, the UE 10 transmits a buffer status report (BSR) when a BSR trigger condition is satisfied, wherein the BSR trigger condition comprises at least one of: a change of data volume associated with a logical channel (LCH) or a logical channel group (LCG) or a protocol data unit (PDU) set exceeds a data volume change threshold, wherein the data volume change threshold is configured by the gNB via radio resource control (RRC) signaling; or a remaining time associated with an LCH or an LCG or a PDU set reaches a remaining time threshold, wherein the remaining time threshold is configured by the gNB via RRC signaling.

The gNB 20 allocates uplink resources (e.g., service-associated uplink resources) in response to the delay-contained BSR (304).

The gNB 20 transmits an indication of the allocated uplink resources to the UE 10 (306).

The UE 10 obtains from the gNB 20 an indication of uplink resources allocated by the gNB 20 (307).

The UE 10 allocates the uplink resources to logical channels (LCHs) during a logical channel prioritization (LCP) procedure (309).

In an embodiment, a format of the BSR comprises one medium access control (MAC) control element (CE) or two MAC CEs. In buffer status reporting, the UE uses one MAC CE to report buffer size and delay information, wherein the delay information is a remaining time of a delay budget for a buffer size of an LCH or an LCG or a PDU set. The MAC CE may comprise delay information with respect to different ranges of the buffer size.

In an embodiment, in buffer status reporting, the UE uses a first MAC CE to report buffer size and uses a second MAC CE to report delay information. The buffer size in the first MAC CE and the delay information in the second MAC CE are associated through a field of the logical channel (LCH) ID or a field of the logical channel group ID or PDU set ID.

Embodiments of the solutions to differentiated scheduling indication and resource allocation are detailed in the following.

To deal with the problem of how can a gNB perform differentiated scheduling based on the data volume reported by BSR of different services (XR services and traditional legacy services), three sub-problems are identified.

The first sub-problem is: How does UE report two different types of BSR (XR BSR and legacy BSR) simultaneously.

Regarding the issue of how to present the data volume (known as buffer size in the 3GPP standards TS 38.321) in buffer status reporting (BSR) and delay information to the gNB at the same time, the disclosure provides two types of solutions: (1) Method 1: Buffer size and delay information (e.g., remaining time) are presented in one BSR. Namely, one BSR can be used for reporting of both legacy BSR information (only buffer size) and XR BSR information (buffer size and delay information). The delay information shall be discernable as to which part of a BSR (e.g., buffer or LCH/LCG) the delay information (e.g., remaining time) represents, corresponds to, or associates with. The delay information can be reported through the legacy BSR or new other MAC CE. (2) Method 2: Buffer size and delay information (e.g., remaining time) are presented in different UL MAC CEs. Namely, buffer size information is reported in a BSR and delay information (e.g., remaining time) is reported in a new UL MAC CE. Therefore, the association between the BSR and the new UL MAC CE should be provided, such as based on an identifier of a logical channel, and two UL MAC CEs (i.e., the BSR and the new UL MAC CE) can be reported to the gNB at the same time. The gNB can identify the relationship or association between the two UL MAC CEs, such as based on the identifier of a logical channel.

In addition, a triggering mechanism for triggering the XR BSR is also provided. XR BSR refers to BSR for XR service.

The second sub-problem is: How the gNB performs differentiated resource scheduling and resource indication based on different services.

In some embodiments of the disclosure, a gNB may explicitly or implicitly indicate differentiated resource information in downlink control information (DCI) for XR services and non-XR services.

The third sub-problem is: How does UE conduct differentiated resource allocation for two different types of services?

In some embodiments of the disclosure, a UE performs delay-based LCP to allocate resources to logical channels.

### Embodiment 1 (BSR Trigger Mechanism Based on Buffer Size Change)

After analysis of first sub-problem, in order to support both the legacy and XR services, the UE needs to report both the BSR of legacy services and the BSR of XR services to a gNB. In the reporting process of BSR, data traffic events of LCHs trigger the reporting of BSR. According to the standard protocol, for legacy service, when the trigger condition of BSR is met, that is, a high priority logical channel LCH (an LCH that belongs to an LCG caching UE buffer data) has new data arrival or a BSR timer timeout, the UE will report a BSR with an appropriate BSR format and a BSR type to the gNB according to the actual situation. However, how to trigger BSR for XR services needs to be redesigned. In the following, an XR BSR trigger mechanism based on buffer size change is disclosed.

The XR service involves the application layer and may comprise video frames, where the traffic data of the XR service is transmitted in units of PDU sets on Uu interface. One PDU set contains multiple data packets, and one PDU set represents one video frame. Some PDU sets have data packets that have an inter-packet correlation or inter-PDU-set correlation, and the application layer of the receiver device needs complete PDU set information (that is, all packets are needed by application layer to decode the video frame) to correctly receive and decode the video information. Therefore, when the core network transmits data to the gNB, each PDU set uses the PDU set Integrated Indication (PSII) parameter to tell the gNB whether all the packets are needed by an upper layer (e.g., the application layer). Based on this, when transferring XR service data on Uu interface, if the PDU set Integrated Indication (PSII) is set for a certain PDU set, and one packet of this PDU set is dropped, the entire PDU set is discarded by the gNB. When such a situation occurs for one or more PDU sets, the data volume (buffer size) in the current LCH changes substantially. If the gNB does not obtain the information on buffer size change, the gNB may allocate more resources than UE needs, leading to a waste of resources. In addition, due to the characteristics of XR service jitter, suddenly a very large number of data bursts may arrive at the Uu interface, and if the gNB does not get the information of buffer size change, the gNB may allocate resources much less than UE needs, so that the UE data is not timely served by resource scheduling, resulting poor user experience. Therefore, it is necessary to consider the XR BSR triggering mechanism based on buffer size changes. Specifically, the following XR BSR triggering schemes are based on the buffer size change: 1 When the data volume of a buffer size associated with an LCH/LCG increases or decreases and reaches a certain threshold value, the UE triggers the report of XR BSR. 2 When the data volume of a buffer size associated with an LCH/LCG increases or decreases to a certain threshold ratio, the UE triggers the report of XR BSR. 3 When the PDU set number of an LCH/LCG/PDU SET increases or decreases reaches a certain threshold, the UE triggers the report of XR BSR. 4 When the PDU set number of an LCH/LCG increases or decreases to a certain threshold ratio, the UE triggers the report of XR BSR.

The threshold value or threshold ratio is referred to as data volume change threshold. For the XR BSR triggering mechanism, the gNB needs to configure the data volume change threshold for an LCH/LCG. The data volume change threshold is set by the gNB for comparison with a change of data volume associated with a logical channel (LCH) or a logical channel group (LCG) or a protocol data unit (PDU) set. The data volume change threshold may be a threshold value or a ratio of the data volume. The data volume may be a measure of data in bits, bytes, or a number of PDU sets. The data volume associated with the logical channel or the logical channel group comprises data volume in a buffer size associated with the logical channel or the logical channel group. The data volume associated with the logical channel or the logical channel group comprises a number of protocol data unit (PDU) set associated with the logical channel or the logical channel group. The change of data volume associated with the logical channel or the logical channel group comprises an increase or a decrease of data volume in the buffer size.

### Embodiment 2 (Delay-Timeout-Based Trigger Mechanism)

After analysis of first sub-problem, in order to support both the legacy and XR services, the UE needs to report both the BSR of legacy services and the BSR of XR services to a gNB. In the reporting process of BSR, data traffic events of LCHs trigger the reporting of BSR. According to the standard protocol, for legacy service, when the trigger condition of BSR is met, that is, a high priority logical channel LCH (an LCH that belongs to an LCG caching UE buffer data) has new data arrival or a BSR timer timeout, the UE will report a BSR with an appropriate BSR format and a BSR type to the gNB according to the actual situation. However, how to trigger BSR for XR services needs to be redesigned. In the embodiment, a remaining time timeout-based XR BSR trigger mechanism is provided.

According to the latest 3GPP standard agreements, a UE should report the delay information (e.g., remaining time) when reporting data volume (buffer size) for the XR service, that is, the report of the remaining time and the report of the data volume for LCH(s)/LCG(s) are correlated and transmitted by the UE on Uu interface to gNB. Based on the information, the gNB can get levels of emergency for different data volumes of LCH(s)/LCG(s) and perform resource scheduling based on the levels of emergency. Based on this analysis, the UE shall report content of XR BSR based on the delay information associated with specific data volumes. Delay information may comprise at least a delay budget or a remaining time in the delay budge. The delay budget may comprise PDU set delay budget (PSDB). Therefore, the delay-timeout-based trigger mechanism can be used to trigger reporting of XR BSR. In the embodiment, a certain threshold may be set by the gNB for the trigger mechanism. The threshold may be referred to as threshold remaining time limit. The threshold remaining time limit may be timed by a timer (referred to as a delay timer), and the remaining time associated with a reported data volume (associated with the LCH or the LCG) reaches the threshold remaining time limit when the timer expires. For example, when the remaining time of a certain data volume is lower than threshold remaining time limit or the delay timer timeout, the UE triggers BSR. The specific scheme of the trigger mechanism is detailed in the following:

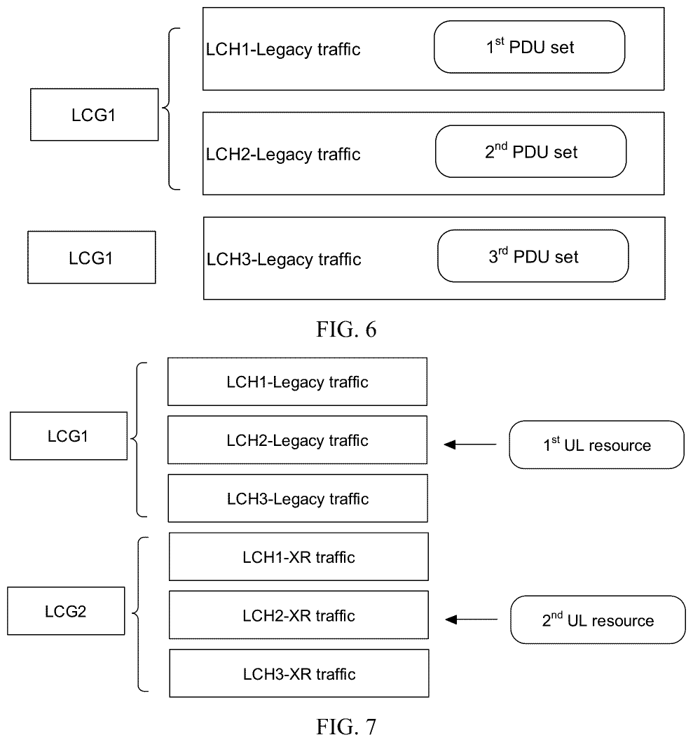

The threshold remaining time limit can be a specific delay information (e.g., remaining time) value or a ratio. The threshold remaining time limit can be at granularity of an LCG/an LCH/a PDU set. FIG. 6 shows the relationship between LCG and LCH and PDU set: PDU set is located in LCHs, and each LCH belongs to an LCG.

### 1 LCG Based Timeout Trigger Mechanism:

In an embodiment, the threshold remaining time limit is timed by a timer configured for the LCG. The remaining time associated with the LCH or the LCG may be an average remaining time or a minimum remaining time of LCHs in an LCG. From the perspective of the current standard protocol, the gNB has no configuration of LCG, and the standard protocol only specifies which LCG the LCHs belong to. Current 3GPP standards do not provide enhancement to LCG. From an implementation perspective, however, the LCG can be used to report the delay information of the LCH. For example, if an LCH is configured with remaining time (calculated from PSDB or packet delay budget (PDB) through QoS flow), the average or minimum remaining time of the LCHs is used as the remaining time of the LCG, and the XR BSR can be triggered when remaining time of LCH reaches the threshold remaining time limit.

Optionally, setting a delay timer based on the granularity of LCG according to the threshold remaining time limit is also a mechanism to trigger XR BSR reporting. The UE transmits a BSR as shown in the disclosure when the delay timer expires (timeout).

In this case, the threshold remaining time limit or the timer is configured for LCG by gNB.

### 1 LCH Based Timeout Trigger Mechanism:

In an embodiment, the threshold remaining time limit is timed by a timer configured for the specific LCH. The remaining time associated with the LCH may be an average remaining time or a minimum remaining time of PDU sets located in a specific LCH.

From the perspective of the current standard protocol, the configuration of LCH is set per UE. The LCH configuration includes the basic LCP parameters (priority/PBR/BSD) and parameters that limit the PUSCH resources used by LCH (such as a list of allowed SCS, etc.). In an embodiment, the delay information is used in the timeout-based trigger mechanism of LCH. Basically, the average or minimum remaining time of a PDU set located in the LCH can be treated as a remaining time of the LCH. Alternatively, the gNB can configure a threshold remaining time limit in the LCH configuration for each LCH.

Optionally, setting a delay timer based on the granularity of LCH according to the threshold remaining time limit is also a mechanism to trigger XR BSR reporting. The UE transmits a BSR as shown in the disclosure when the delay timer expires (timeout).

In this case, the threshold remaining time limit or the timer is configured for LCH by gNB.

### 1 PDU Set Based Timeout Trigger Mechanism:

In an embodiment, the threshold remaining time limit is timed by a timer configured for protocol data unit (PDU) sets associated with the LCH or the LCG.

PSDB (PDU set delay budget) is one of the basic parameter information of PDU set in Uu transmission. The gNB can set a threshold according to PSDB for each PDU set, and XR BSR reporting should be triggered when a certain PDU set delay threshold is reached. The delay timeout threshold (or timer timeout) is also a reasonable way.

Optionally, setting a delay timer based on the granularity of PDU set according to the threshold remaining time limit is also a mechanism to trigger XR BSR reporting. The UE transmits a BSR as shown in the disclosure when the delay timer expires (timeout).

In this case, the threshold remaining time limit or the timer is configured for PDU set by gNB.

### Embodiment 3 (Format of Legacy BSR and XR BSR Mechanism)

After analysis of first sub-problem, in order to support both the legacy and XR services, the UE needs to report both the BSR of legacy services and the BSR of XR services to a gNB. In addition to the trigger mechanism of BSR as detailed in the above embodiment, the reporting method of BSR also needs further enhancement, including formatting of the BSR reported to the gNB. The specific scheme is detailed in the following: Option 1: UE uses one BSR to report two kinds of information of both services (i.e., buffer size information of legacy service as well as buffer size and delay information of XR service) simultaneously.

The data volume (buffer size) is reported together with delay information in this scheme. In the option, the reported BSR supports BSR MAC CE format of legacy service (only buffer size information of legacy service is reported), and supports BSR MAC CE of XR services (both buffer size information and delay information of XR services are reported). It also supports BSR MAC CE for both legacy and XR services (reporting buffer size information for legacy services, and the buffer size information and delay information of XR service). In the scheme of the option 1, the buffer size information and delay information are presented in one BSR, as illustrated in the following:

a) The UE takes different ranges of the delay information as the basic unit of granularity for reporting of buffer size in BSR. The BSR shows that every LCG/LCH has a number of ranges of remaining time, and each range of remaining time has how much data volume (buffer size). Table 1 shows an example of the association between the range of remaining time and data volume in BSR.

TABLE 1

| Range of remaining time | Data volume (buffer size) |
|---|---|
| 0 to10 ms | 1^{st} buffer size |
| 1 to 20 ms | Second buffer size |
| . . . | |

In the embodiment, the UE uses one MAC CE to report buffer size of a legacy service as well as a buffer size and delay information of an extended reality (XR) service. The MAC CE comprises buffer size of the XR service with respect to different ranges of the delay information of the XR service.

b) The UE takes PDU set as the basic unit of granularity for reporting of buffer size in BSR. The BSR shows that every LCG/LCH has a number of PDU sets, and each PDU set has how much data volume (buffer size) and how many remaining time. Table 2 shows an example of the association between the range of remaining time and data volume in BSR.

TABLE 2

| PDU set | remaining time | Data volume (buffer size) |
|---|---|---|
| 1^{st} PDU set | 10 ms | 1^{st} buffer size |
| 2^{nd} PDU set | 20 ms | 2^{nd} buffer size |
| . . . | | |

Option 2: UE uses two BSRs to report two kinds of information of both services (i.e., buffer size information of legacy service as well as buffer size and delay information of XR service), where one BSR is for buffer status (i.e., buffer size information) for legacy service and XR service, the other BSR is for delay information of XR service.

To be specific, data volume is reported with a legacy BSR, and delay information are reported with a new BSR/UL MAC CE. In this scheme, the delay information and buffer size information of XR BSR belong to different UL MAC CEs respectively, and the gNB needs to obtain the buffer size information and delay information simultaneously when obtaining the information of XR. Therefore, the two BSRs need to have an associated relationship. For example, the relationship between the two BSRs can be based on the LCG/LCH ID fields.

In the embodiment, in buffer status reporting, the UE uses a first MAC CE to report buffer size of a legacy service and a buffer size of an XR service and uses a second MAC CE to report delay information of the XR service. The buffer size of the XR service in the first MAC CE and the delay information of the XR service are associated through a field of the logical channel (LCH) ID or a field of the logical channel group ID.

Option 3: The UE reports a legacy BSR and an XR BSR independently. That is, two different services are independently reported with different BSRs.

In this scheme, legacy BSR is reported according to the current standard mechanism, and XR BSR is an independent UL MAC CE, which is different from legacy BSR, and is reported independently. The XR BSR mainly contains buffer size of the XR service and delay information of each buffer size. How to distinguish which delay information corresponds to which buffer size can be referenced to the scheme of Option1.

In the embodiment, in buffer status reporting, the UE uses a first MAC CE to report buffer size of a legacy service, and uses a second MAC CE to report a buffer size and delay information of an XR service.

### Embodiment 4 (Resource Scheduling and Indication Based on Service Type Differentiation)

After receiving the BSR of the two types of services, the gNB should allocate resources to the two types of services based on differentiated scheduling, and the gNB shall allocate resources based on the delay information (of XR service) and buffer size information in BSR. The delay information represents the urgency level of the XR service, and buffer size represents the amount of current traffic data of the XR service. Since XR services and legacy services have different bandwidth/delay/resource requirements, the XR services and legacy services may correspond to different physical layer parameters and resource requirements. Based on this, the above factors need to be considered comprehensively when the gNB schedules physical resources for the two types of services simultaneously. Therefore, the gNB may need to allocate two sets of physical resources with different numerologies to legacy service and XR service. The procedure is shown in FIG. 4. FIG. 4 shows resource allocation and indication based on the differentiation of service types. The UE obtains the indication of the uplink resources from the gNB by DCI0. The uplink resources in the indication are identified by at least one of the following identifiers (IDs): LCH ID/LCG ID/DRB ID.

In an embodiment, in steps 207 and 208, the gNB transmits the indication in two pieces of DCI0 to the UE. The UE receives two resource allocation indications, and each of the two resource allocation indications indicates physical resource allocation information for two types of services including a non-XR service and an XR service.

Alternatively, the gNB transmits the indication in two pieces of DCI0 to the UE. The UE receives one resource allocation indication, and the resource allocation indication indicates physical resource allocation information for two types of services including a non-XR service and an XR service.

When allocating two sets of physical resources for the two types of services, the gNB transmits an indication of allocation information of the two sets of physical resource to UE through DCI0. However, in the standard protocol, for the two different uplink resource sets, it is not clear how can the gNB indicates allocation of the two sets of physical resources for different kinds of services. Hence, the physical resource indication mechanism of the gNB needs to be enhanced. Specifically, embodiments of two methods are detailed in the following:

Method 1: The gNB explicitly transmits two DCI0s to the UE, and each DCI0 indicates the physical resource allocation information for the two types of services. In this mechanism, two DCI0s need to carry identification information which is used to distinguish between different services by the UE. The identification information is illustrated in the following:

Since different service types are carried on LCHs and transmitted through DRBs, and LCHs belonging to one or more LCGs, in order to distinguish between different services in DCI0, the gNB carries ID information of LCH/LCG/DRB in each DCI0. The DCI received by the UE comprises identification information of one or more of LCH, LCG, and dynamic radio bearer (DRB) in the resource allocation indications.

Optionally, since the legacy service only contains buffer size information, and the XR service has buffer size information and delay information, in order to distinguish between different services in DCI0, the gNB carries delay information to indicate the resource information for XR services in XR specific DCI0. The DCI received by the UE comprises delay information of an XR service to associate with the physical resource allocation information for the XR service.

Optionally, a predefined table is designed between UE and gNB, and the predefined table provides the relationship of ID of DCI0 and ID of service type. Thus, when DCI0 is sent with the ID representing the service type by gNB, the UE can also accurately get which DCI0 has the indication of resources allocation for which type of service using the predefined table. The DCI received by the UE comprises a service identifier of the XR service. The service identifier of the XR service is preconfigured in a lookup table.

Method 2: The gNB transmits one DCI0 to the UE, and the DCI0 indicates the physical resource allocation information for the two sets of services. In this mechanism, DCI0 needs to carry identification information that can distinguish between different services. Embodiments of the method 2 are illustrated in the following:

Since different service types are carried on LCHs and transmitted through DRBs and LCHs belonging to one or more LCGs, in order to distinguish between different services in DCI0, the gNB carries ID information of LCH/LCG/DRB for each allocated physical resource in DCI0. The DCI received by the UE comprises identification information of one or more of LCH, LCG, and dynamic radio bearer (DRB) in the resource allocation indications.

Optionally, since the legacy service only contains buffer size information, and the XR service has buffer size information and delay information, in order to distinguish between different services in DCI0, the gNB carries delay information to indicate the resource information for XR services in DCI0. The DCI received by the UE comprises delay information of an XR service to associate with the physical resource allocation information for the XR service.

### Embodiment 5 (Uplink Resource Allocation Based on Different Service Types)

In order to address the second sub-problem, the gNB provides UE two sets of physical resources corresponding to legacy service and XR service respectively, and the UE allocates resources after receiving the physical resources indicated by the gNB. As shown in the figure, UE may receive two sets of uplink physical resources, i.e., UL resource R1 and UL resource R2, from the gNB.

Further, the gNB needs to consider how to perform efficient uplink resource allocation. The uplink resource allocation procedure has two parts: inter-resource allocation between the legacy service and XR service, and intra-resource allocation within the legacy service or XR service.

The current standard protocol can be used for the intra-resource allocation within the legacy service. In the current standard protocol, a specific algorithm is based on the priority of LCH and the upper limit of resources allocated for each LCH.

For the inter-resource allocation between the XR service and legacy service and intra-resource allocation within the XR service, a resource allocation mechanism between the legacy service (i.e., non-XR service) and XR service needs to be defined. An embodiment of the resource allocation mechanism is illustrated in the following:

### Inter-Resource Allocation Between the XR Service and Legacy Service:

When both legacy and XR services are present in the system, the deployment of XR and legacy services may belong to different LCG as shown in FIG. 7 or belong to the same LCG. In either case, however, each XR service or legacy service is using a separate DRB which is located in an independent LCH. Therefore, the gNB only needs to reclassify legacy service and XR service according to LCH or DRB, and then assign specific UL resources belonging to legacy service and UL resource belonging to XR service respectively. For legacy service, the UL resource allocation for the legacy service follows the LCP process of the current standard protocol (the specific algorithm is based on the priority of LCH and the upper limit of resources allocated for each LCH), while the UL resource allocation for the XR service, namely the intra-resource allocation within the XR service, is illustrated in the following.

Intra-Resource Allocation within the XR Service:

When receiving the UL resource of XR service from gNB, the UE uses the resources of the UL resource of XR service for transmission of the XR service data which is carried by LCH. As specified 3GPP standard protocol TS38.321-5.4.3.1.3, the UE decides the amount of resources allocated for each LCH using the token bucket algorithm of the LCP process. The specific algorithm is based on the priority of LCH and the upper limit of each resource to be allocated per LCH each time. Specifically, UE allocates UL resources to each LCH that meets the limited resource to be allocated in descending order of LCH priority. Each LCH is assigned a token variable Bj (Bj is the maximum of the token barrel). Before each LCP procedure, Bj will increase one unit, and after each LCP procedure, Bj will deduct the size of the allocated resources that is allocated to the LCH during the LCP process. If there are any remaining resources after the LCP, each LCH is assigned resource only based on LCH priority not considering the Bj.

The current mechanism does not consider the delay information (e.g., remaining time). The delay information of XR service is a very important influence factor during resource scheduling and allocation. If packets of XR service are not scheduled within the specified time (i.e., delay budget), the packets cannot be decoded at the receiver device, which will greatly affect the user experience. In this case, for intra-resource allocation within the XR service, both remaining time and the priority of LCH used in the traditional LCP resource allocation need to be considered. In some embodiments, the UE uses delay information to allocate the uplink resources to logical channels (LCHs) during the LCP procedure. The delay information for LCH of the UE is configured by the gNB using RRC signaling. Examples of the delay information comprise the PSDB, PDB, remaining time, and the delay timer.

wherein the delay information comprises delay priority value or delay-sensitive indication. The specific scheme is illustrated in the following:

Scheme 1 (LCH prioritization is the baseline, combined with remaining time prioritization for resource allocation): the UE allocates physical resources to buffers of the XR service according to LCH prioritization as a baseline combined with remaining time prioritization.

Step1: The UE arranges buffers of LCHs for XR services in ascending order of LCH priority values of the LCHs (the lower the LCH priority value, the higher the LCH priority), and arranges the buffers in each LCH priority value in ascending order of remaining time value (the smaller the remaining time value of a buffer, the higher the priority of the buffer) of the buffers.

Step2: The UE calculates an average value of all remaining time values of the buffers of the XR service and takes the average value as a remaining time threshold. Alternatively, the gNB sets a remaining time threshold to UE. The UE obtains buffers from the highest LCH priority value to the lowest LCH priority value, and, for each buffer of each LCH priority value, the UE performs the following: If the remaining time value of the buffer is lower than the remaining time threshold, the UE preferentially allocates resource the buffer according to the LCH priority value of the buffer. If the remaining time value of the buffer is not lower than the remaining time threshold, the UE does not preferentially allocate resource to the buffer.

Step3: When all buffer with remaining time value less than the remaining time threshold is allocated resources, and there are still remaining resources in the current UL resource, UE will allocate resource to the buffer for who's remaining time value higher than the remaining time threshold according to the priority of the LCH.

Scheme 2 (remaining time prioritization is the baseline for resource allocation, combined with LCH prioritization): the UE allocates physical resources to buffers of the XR service according to remaining time prioritization as a baseline combined with LCH prioritization.

Step1: The UE arranges buffers of LCHs for XR services in ascending order of the remaining time priority (the lower the remaining time priority value of a buffer, the higher the remaining time priority of the buffer) of the buffers, and arranges buffers of in each remaining time priority value (reflecting remaining time values or ranges of remaining time value) in ascending order of LCH priority values of the buffers (the smaller the LCH priority value of a buffer, the higher the priority of the buffer).

Step2: The UE calculates an average value of located LCH priority values of the buffers of the XR service and takes the average value as a located LCH priority threshold. Alternatively, the gNB sets an LCH priority threshold to UE. The UE obtains buffers from the highest remaining time priority value to the lowest remaining time priority value, and, for each buffer of each remaining time priority value, the UE performs the following: If the located LCH priority value of the buffer is lower than the located LCH priority threshold, the UE preferentially allocates resource the buffer according to the remaining time priority value. If the located LCH priority value of the buffer is not lower than the located LCH priority threshold, the UE does not preferentially allocate resource to the buffer.

Step3: When all buffer with located LCH priority value less than the located LCH priority threshold has allocated resources, and there are still remaining resources in the current UL resource, UE will allocate resource to the buffer for who's located LCH priority value higher than the LCH priority threshold according to the priority of the remaining time.

In the description, embodiments are provided to address the issue of how to perform differentiated scheduling with two kinds of BSR reporting (XR service and traditional legacy service BSR). The disclosure provides: A mechanism in which a UE reports data volume of different services (XR services and traditional legacy services) by BSR (XR BSR and/or legacy BSR) simultaneously. A mechanism in which a UE reports data volume of different services (XR services and traditional legacy services) by BSR (XR BSR and/or legacy BSR) simultaneously. A mechanism in which a gNB performs differentiated scheduling and differentiated resource allocation indication. A mechanism in which a UE performs resource allocation for two different services (XR services and traditional legacy services).

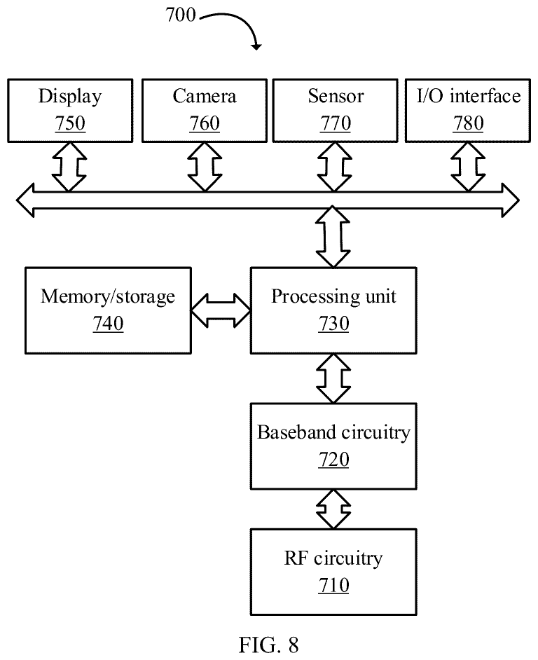

FIG. 8 is a block diagram of an example system 700 for wireless communication according to an embodiment of the present disclosure. Embodiments described herein may be implemented into the system using any suitably configured hardware and/or software. FIG. 8 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in 3GPP specification to create an end product.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. An uplink resource processing method, executable in a user equipment (UE), comprising:
reporting a delay-contained buffer status report (BSR) to a base station.

2. The method of claim 1, wherein the delay-contained BSR comprises delay information and buffer size of a logical channel group (LCG);
wherein the delay information is remaining time of an LCG;
wherein the buffer size is remaining time associated data volume of an LCG.

3. The method of claim 1, wherein the reporting delay-contained BSR to the base station further comprising:
triggering a buffer status report (BSR) for a logical channel (LCH) when the remaining time of traffic data located in an LCH lower than a remaining time threshold.

4. The method of claim 1, wherein the remaining time threshold is configured by the base station to a medium access control (MAC) entity of the UE via a radio resource control (RRC) signaling.

5. The method of claim 1, wherein in buffer status reporting, the UE uses one MAC CE to report buffer size and delay information, wherein the delay information is a remaining time of a delay budget for a buffer size of an LCH or an LCG or a PDU set.

6. The method of claim 5, wherein the MAC CE comprises delay information with respect to different ranges of the buffer size.

7. The method of claim 2, wherein in buffer status reporting, the UE uses a first MAC CE to report buffer size and uses a second MAC CE to report delay information.

8. The method of claim 7, wherein the buffer size in the first MAC CE and the delay information in the second MAC CE are associated through a field of the logical channel (LCH) ID or a field of the logical channel group ID or PDU set ID.

9. The method of claim 1, wherein the UE obtains the indication of the uplink resources from the base station by DCI0;
wherein the uplink resources in the indication are identified by at least one of the following identifiers (IDs): LCH ID/LCG ID/DRB ID.

10. The method of claim 1, wherein the UE uses a delay information to allocate the uplink resources to logical channels (LCHs) during the LCP procedure;
wherein the delay information for LCH of the UE is configured by the base station using RRC signaling;
wherein the delay information comprises delay priority value or delay-sensitive indication.

11. A user equipment (UE) comprising:
a processor, configured to call and run a computer program stored in a memory, to cause a device in which the processor is installed to execute an uplink resource processing method comprising:
reporting a delay-contained buffer status report (BSR) to a base station.

12. The UE of claim 11, wherein the delay-contained BSR comprises delay information and buffer size of a logical channel group (LCG);
wherein the delay information is remaining time of an LCG;
wherein the buffer size is remaining time associated data volume of an LCG.

13. The UE of claim 11, wherein the reporting delay-contained BSR to the base station further comprising:
triggering a buffer status report (BSR) for a logical channel (LCH) when the remaining time of traffic data located in an LCH lower than a remaining time threshold.

14. The UE of claim 11, wherein the remaining time threshold is configured by the base station to a medium access control (MAC) entity of the UE via a radio resource control (RRC) signaling.

15. The UE of claim 11, wherein in buffer status reporting, the UE uses one MAC CE to report buffer size and delay information, wherein the delay information is a remaining time of a delay budget for a buffer size of an LCH or an LCG or a PDU set.

16. The UE of claim 15, wherein the MAC CE comprises delay information with respect to different ranges of the buffer size.

17. The UE of claim 11, wherein in buffer status reporting, the UE uses a first MAC CE to report buffer size and uses a second MAC CE to report delay information.

18. The UE of claim 17, wherein the buffer size in the first MAC CE and the delay information in the second MAC CE are associated through a field of the logical channel (LCH) ID or a field of the logical channel group ID or PDU set ID.

19. The UE of claim 11, wherein the UE obtains the indication of the uplink resources from the base station by DCI0;
wherein the uplink resources in the indication are identified by at least one of the following identifiers (IDs): LCH ID/LCG ID/DRB ID.

20. The UE of claim 11, wherein the UE uses a delay information to allocate the uplink resources to logical channels (LCHs) during the LCP procedure;
wherein the delay information for LCH of the UE is configured by the base station using RRC signaling;
wherein the delay information comprises delay priority value or delay-sensitive indication.
